(19) United States
(12) Patent Application Publication
(10) Pub. No.: US 2022/0410788 A1
(43) Pub. Date: Dec. 29, 2022

(54) MOBILE SELF-CONTAINED STOREFRONT

(71) Applicant: Ashley Nicole Girard, Marina del Rey, CA (US)

(72) Inventor: Ashley Nicole Girard, Marina del Rey, CA (US)

(21) Appl. No.: 17/808,440

(22) Filed: Jun. 23, 2022

Related U.S. Application Data
(60) Provisional application No. 63/202,762, filed on Jun. 23, 2021.

(51) Int. Cl. B60P 3/025; B60R 15/00; B62D 33/04; B60P 3/20

(52) U.S. Cl. CPC B60P 3/0257; B60R 15/00; B62D 33/048; B60P 3/20

(57) ABSTRACT

A mobile store includes a frame supported by wheels and a body enclosure mounted on the frame. The body enclosure is formed of a front wall, a first longitudinal sidewall, a second longitudinal sidewall, a rear wall, and a roof. The body enclosure is divided into a working chamber and a storage-and-hygiene chamber by an interior wall having an interior door. The first longitudinal sidewall includes a first transaction window. The second longitudinal sidewall includes a second transaction window. The rear wall has a doorway with an entry door mounted with hinges to the rear wall to close the doorway. A first awning mounted with hinges to the first longitudinal sidewall closes the first transaction window. A second awning mounted with hinges to the second longitudinal sidewall closes the second transaction window. The mobile store unites the convenience of a convenience store with the flexibility of a food truck.

### CROSS-REFERENCE TO RELATED APPLICATION

This application claims the benefit of priority of U.S. provisional application No. 63/202,762, filed Jun. 23, 2021, the contents of which are herein incorporated by reference.

### BACKGROUND OF THE INVENTION

The present invention relates to a mobile retail sales unit and, more particularly, to a mobile self-contained storefront.

Retail spaces are generally fixed in location and cannot “move” to address changes in foot traffic. Retail space is too permanent and often too expensive, in part because retail units often rely on rent and permits. Convenience stores are expensive and not truly convenient—you must go to them.

Mobile units generally do not have running water and/or a bathroom on-site. Commercially available campers do not have enough internal space for storage and merchandising for a store. Food trucks are too big and require too many permits or specialists to operate. And novelty carts such as those used to sell Havaianas® merchandise do not have electricity, running water, or toilets on board.

A mobile retail unit that is self-contained and does not require special parking or health permits does not exist.

As can be seen, there is a need for a mobile unit that provides basic storage and display to sell product.

### SUMMARY OF THE INVENTION

In one aspect of the present invention, a mobile store comprises a frame supported by wheels and a body enclosure, mounted on said frame, wherein said body enclosure is divided into a working chamber and a storage-and-hygiene chamber by an interior wall having an interior door. The body enclosure comprises a front wall; a first longitudinal sidewall, having a first transaction window formed therein, joined with the front wall; a second longitudinal sidewall, having a second transaction window formed therein, joined with the front wall opposite the first longitudinal sidewall; a rear wall, having a doorway formed therein, joined with the first longitudinal sidewall and the second longitudinal sidewall opposite the front wall; a roof joined with the front wall, the first longitudinal sidewall, the second longitudinal sidewall, and the rear wall; an entry door hingedly mounted to the rear wall and configured to close the doorway; a first awning hingedly mounted to the first longitudinal sidewall and configured to close the first transaction window; and a second awning hingedly mounted to the second longitudinal sidewall and configured to close the second transaction window.

The mobile store combines the convenience of a convenience store (storage, display, bathroom, sink, light) and the flexibility of a food truck in a unit that supports the needs of a business.

These and other features, aspects and advantages of the present invention will become better understood with reference to the following drawings, description, and claims.

### BRIEF DESCRIPTION OF THE DRAWINGS

FIG. 1 is a perspective view of a mobile retail store according to an embodiment of the present invention;

FIG. 2 is a right side elevation view thereof;

FIG. 3 is a left side elevation view thereof;

FIG. 4 is a rear elevation view thereof;

FIG. 5 is a sectional view thereof, taken along line 5-5 in FIG. 3;

FIG. 6 is a sectional view thereof, showing awnings in use;

FIG. 7 is a sectional view thereof, taken along line 7-7 in FIG. 5; and

FIG. 8 is a sectional view of a mobile retail store according to an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a self-contained mobile storefront towable by a mid-sized vehicle, enabling the user to flexibly locate and sell a variety of retail products, goods, and services with retail display elements, on-site electricity, and running water.

As used herein, the term “window” refers to an aperture, pass-through, or opening through which a transaction may be completed, including the transfer of goods and/or services. The use of the term “window” does not imply that a frame, pane, or other parts of a commercial window are present. The terms “hatch” or “portal” may be used interchangeably herein.

As used herein, with the exception of the term “rain awning”, the term “awning” refers to a hatch door that may be hingedly moved between a vertical position sealing a window and a substantially horizontal position enabling access through the window. The use of the term “awning” does not imply manufacture from a fabric material.

The size of the unit generally fits within the dimensions of a standard parking spot, reliant only on local parking rules and regulations. The mobile storefront preferably does not require special license or permits. Two convenient selling windows may be provided, enabling operators to pull up to locations on either side of the street to sell.

Preferably, the mobile storefront includes electrical outlets, a toilet, and sinks. In some embodiments, the mobile storefront may include a shower, a refrigerator, and a freezer.

The mobile storefront may be made from a towable unit such as a storage container, camper, affordable dwelling unit (ADU), etc., and may have a customized interior with retail components such as, but not limited to, hidden storage, extra refrigeration and freezer, and display and merchandising features. The interior layout may be modified.

The mobile storefront offers a self-contained vessel that may be used to sell products such as homemade jewelry; goods such as groceries or homemade jerky; and services like massage, spiritual readings, etc., in various areas.

The materials of manufacture are not particularly limited. Suitable materials may include, for example, diamond-plate stainless steel for flooring and mirror polish stainless steel for the enclosure.

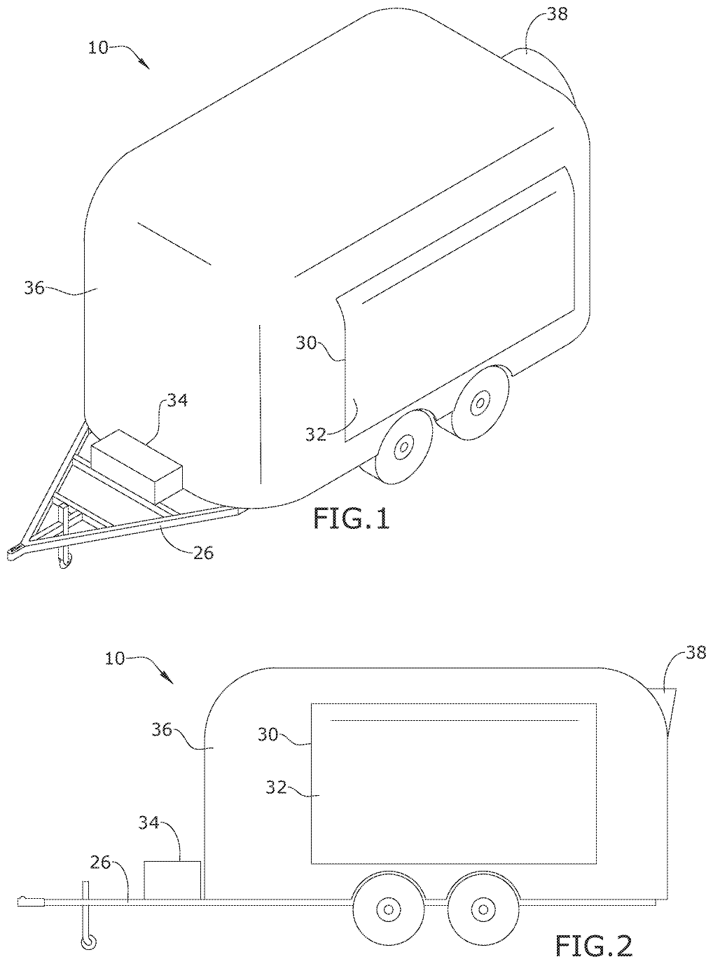

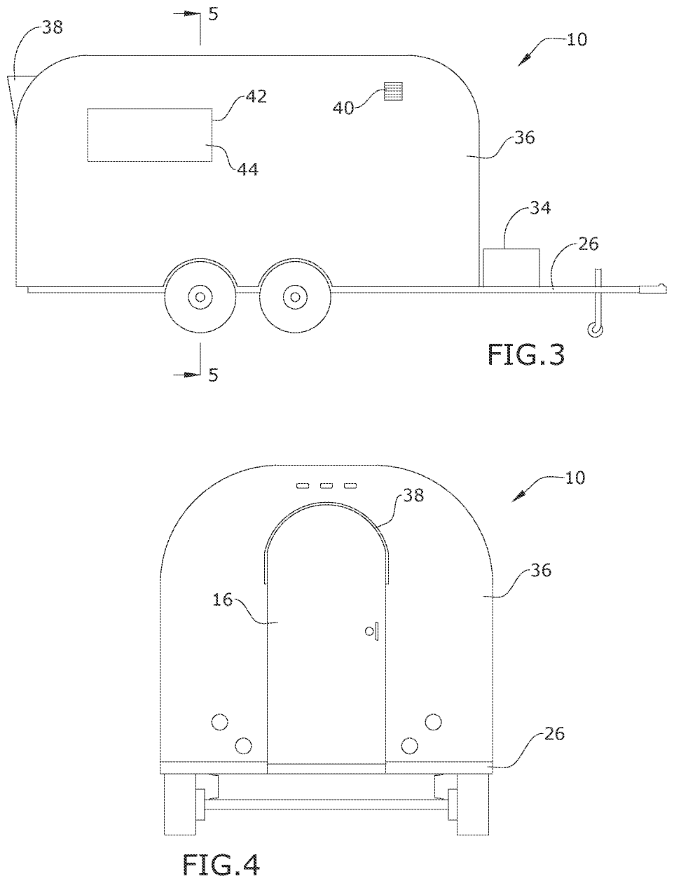

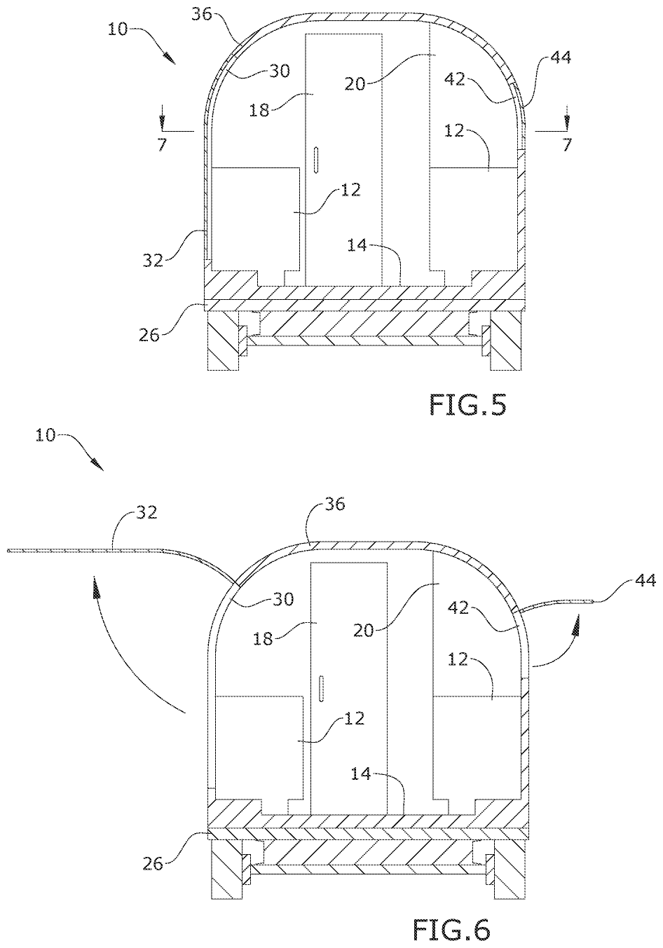

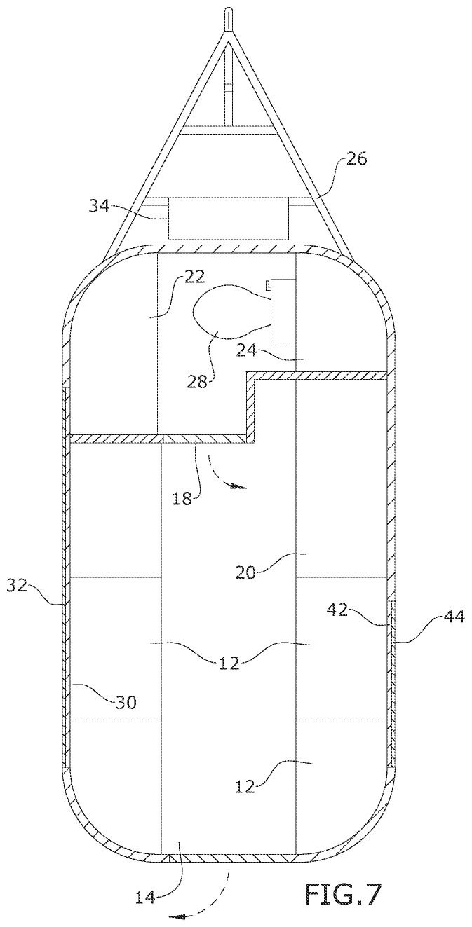

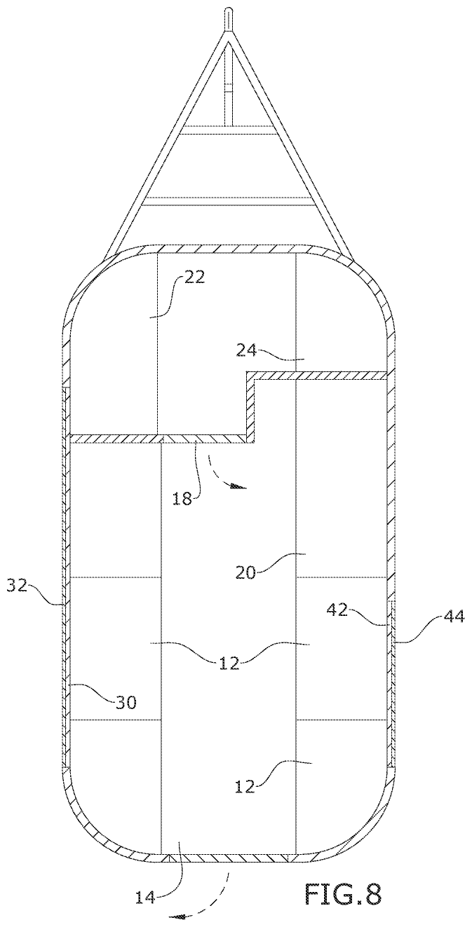

Referring to FIGS. 1 through 8, FIGS. 1 and 2 illustrate a mobile store 10 according to an embodiment of the present invention, comprising; a trailer enclosure or body enclosure 36 formed with four walls (including a front wall, a rear wall, a first longitudinal sidewall and a second longitudinal sidewall) joined with a roof and having a trailer frame 26 with a tow hitch extending from a front portion thereof; a front transaction window 30 on a first longitudinal side with a front window awning 32 that serves as a top-hinged door that seals the front transaction window 30 in a transport position. The trailer frame 26 is supported by wheels. A generator 34 may be mounted to the trailer frame 26. A second longitudinal side opposite the first longitudinal side is illustrated in FIG. 3 and comprises a vent 40 and a rear transaction window 42 with a rear window awning 44 that serves as a top-hinged door that seals the rear transaction window 42 in a transport position. The vent 40 is spaced from the rear transaction window 42. As best seen in FIG. 4, a rear portion of the trailer enclosure 36 comprises an entry door 16 hingedly closing a rear doorway, with a rain awning 38 positioned over the entry door 16. FIGS. 5 through 7 illustrate an interior of the trailer enclosure 36, comprising a working chamber accessible by the rear door 16 and a storage/hygiene chamber separated therefrom or divided by an interior wall with an interior door 18. The working chamber comprises cabinets 12 along the first longitudinal side and the second longitudinal side, forming working surfaces adjacent to and aligned with the transaction windows 30, 42. The cabinets 12 may comprise shelves, one or more sinks, and appliances such as a microwave (not shown). A walkway with flooring 14, such as anti-slip aluminum plate, enables access to various components in the mobile store 10. A refrigerator 20 is mounted to a wall on the second longitudinal side. The refrigerator compartment 20 is operative to maintain its interior region at or below a predetermined temperature. The storage/hygiene chamber comprises full-height storage 22 and additional storage units 24; as well as a hygiene apparatus configured to operate with running water, such as a toilet 28 and, in some cases, a shower (not shown). FIG. 6 illustrates a step of raising the awnings 32, 44 to provide access via the transaction windows 30, 42 for transactions. In an alternate embodiment shown in FIG. 8, the forward chamber of the trailer enclosure provides full-height storage 22 and additional storage 24 with an alternate storage-and-hygiene chamber configuration.

It should be understood, of course, that the foregoing relates to exemplary embodiments of the invention and that modifications may be made without departing from the spirit and scope of the invention as set forth in the following claims.

What is claimed is:

1. A mobile store, comprising:
a frame supported by wheels;
a body enclosure, mounted on said frame, comprising:
a front wall;
a first longitudinal sidewall, having a first transaction window formed therein, joined with the front wall;
a second longitudinal sidewall, having a second transaction window formed therein, joined with the front wall opposite the first longitudinal sidewall;
a rear wall, having a doorway formed therein, joined with the first longitudinal sidewall and the second longitudinal sidewall opposite the front wall;
a roof joined with the front wall, the first longitudinal sidewall, the second longitudinal sidewall, and the rear wall;
an entry door hingedly mounted to the rear wall and configured to close the doorway;
a first awning hingedly mounted to the first longitudinal sidewall and configured to close the first transaction window; and
a second awning hingedly mounted to the second longitudinal sidewall and configured to close the second transaction window;
wherein said body enclosure is divided into a working chamber and a storage-and-hygiene chamber by an interior wall having an interior door.

2. The mobile store of claim 1, wherein the frame further comprises a tow hitch.

3. The mobile store of claim 1, further comprising a generator mounted to the frame.

4. The mobile store of claim 1, further comprising a hygiene apparatus mounted within the storage-and-hygiene chamber and configured to operate with running water.

5. The mobile store of claim 1, wherein the second longitudinal sidewall further comprises a vent spaced from the second transaction window.

6. The mobile store of claim 1, wherein the rear wall further comprises a rain awning positioned above the entry door.

7. The mobile store of claim 1, further comprising a plurality of storage units mounted along an interior of the first longitudinal sidewall and along an interior of the second longitudinal sidewall.

8. The mobile store of claim 7, wherein a walkway is defined between the plurality of storage units from the entry door to the interior door.

9. The mobile store of claim 7, wherein a top of at least one of the plurality of storage units forms a working surface aligned with the first transaction window and/or the second transaction window.

10. The mobile store of claim 7, wherein the working chamber further comprises a refrigerator compartment, mounted among the plurality of storage units, operative to maintain its interior region at or below a predetermined temperature.
